(19) United States
(12) Patent Application Publication
(10) Pub. No.: US 2008/0301314 A1
(43) Pub. Date: Dec. 4, 2008

(54) Auxiliary Content Handling Over Digital Communication Systems

(75) Inventors: Toni Paila, Rye, NY (US); Rod Walsh, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/667,418

(22) PCT Filed: Oct. 12, 2005
(86) PCT No.: PCT/IB05/53353

§ 371 Date: Mar. 17, 2008

(30) Foreign Application Priority Data
Nov. 9, 2004 (GB) 0424724.3

(51) Int. Cl. G06F 15/16; H04M 11/00; H04H 20/71

(52) U.S. Cl. 709/231; 455/403; 709/237; 455/3.01

(57) ABSTRACT

A broadcaster prepares primary content session stream data, and auxiliary content files, such as subtitle text. The auxiliary data may be provided using a two-level structure. Here, the first level can be is a file having plural entries each with a control information item, e.g. a timestamp, and a reference is found. A receiver at a time relating to a timestamp renders video content from a packet (43) having that timestamp, and also renders subtitle text from the second level file (46) having the same reference as the reference corresponding to the timestamp in the first level file. Thus, the broadcaster defines when subtitle text strings are to be rendered but without requiring streaming of packets including the auxiliary data. This makes it easy for a receiver to synchronise the auxiliary data with the primary content. A single level file structure can be used instead.

The invention relates generally to auxiliary content delivery over digital communication systems, and to receiving auxiliary content.

FLUTE is a project managed under the control of the Internet Engineering Task Force (IETF). FLUTE defines a protocol for the unidirectional delivery of files over the Internet. The protocol is particularly suited to multicast networks, although the techniques are similarly applicable for use with unicast addressing. The FLUTE specification builds on Asynchronous Layered Coding (ALC), the base protocol designed for massively scalable multicast distribution. ALC defines transport of arbitrary binary objects, and is laid out in Luby, M., Gemmell, J., Vicisano, L., Rizzo, L. and J. Crowctoft, “Asynchronous Layered Coding (ALC) Protocol Instantiation”, RFC 3450, December 2002. For file delivery applications, the mere transport of objects is not enough. The end systems need to know what do the objects actually represent. FLUTE provides a mechanism for signalling and mapping the properties of files to concepts of ALC in a way that allows receivers to assign those parameters for received objects. In FLUTE, ‘file’ relates to an ‘object’ as discussed in the above-mentioned ALC paper.

In a FLUTE file delivery session, there is a sender, which sends the session, and a number of receivers, which receive the session. A receiver may join a session at an arbitrary time. The session delivers one or more abstract objects, such as files. The number of files may vary. Any file may be sent using more than one packet. Any packet sent in the session may be lost.

FLUTE has the potential be used for delivery of any file kind and any file size. FLUTE is applicable to the delivery of files to many hosts, using delivery sessions of several seconds or more. For instance, FLUTE could be used for the delivery of large software updates to many hosts simultaneously. It could also be used for continuous, but segmented, data such as time-lined text for subtitling, thereby using its layering nature inherited from ALC and LCT to scale the richness of the session to the congestion status of the network. It is also suitable for the basic transport of metadata, for example SDP files which enable user applications to access multimedia sessions. It can be used with radio broadcast systems, as is expected to be particularly used in relation to IPDC (Internet Protocol Datacast) over DVB-H (Digital Video Broadcast-Handheld), for which standards currently are being developed.

A programming language for choreographing multimedia presentations where audio, video, text and/or graphics can be combined in real time has been developed. The language is called Synchronised Multimedia Integration Language (SMIL, pronounced in the same way as ‘smile’) and is documented at www.w3c.org/audiovideo. SMIL allows a presentation to be composed from several components that are accessible from URLs, as files stored on a webserver. The begin and end times of the components of a presentations are specified relative to events in other media components. For example, in a slide show, a particular slide (a graphic component) is displayed when a narrator in an audio component begins to discuss it.

The inventors have considered the possibility of using a file delivery protocol such as FLUTE for the remote provision of multimedia content along with associated auxiliary data, such as text subtitles, synchronised therewith. A proposal for the provision of synchronised subtitles exists as an internet draft dated 10 Sep. 2004 entitled “RTP Payload Format for 3GPP Timed Text” by Matsui and Rey. At the time of writing this is available at http://www.potaroo.net/ietf/idref/draft-ietf-avt-rtp-3gpp-timed-text/. This proposes to provide synchronised text at a receiver using RTP streaming. Timed text data is transmitted immediately before it is due to be rendered, and there is no provision for allowing different text versions, for example in different languages.

The present invention provides a novel scheme for the delivery and rendering at a receiver of auxiliary content.

The invention is as defined in the appended claims.

Embodiments of the invention will now be described, by way of example only, with reference to the accompanying drawings, in which:

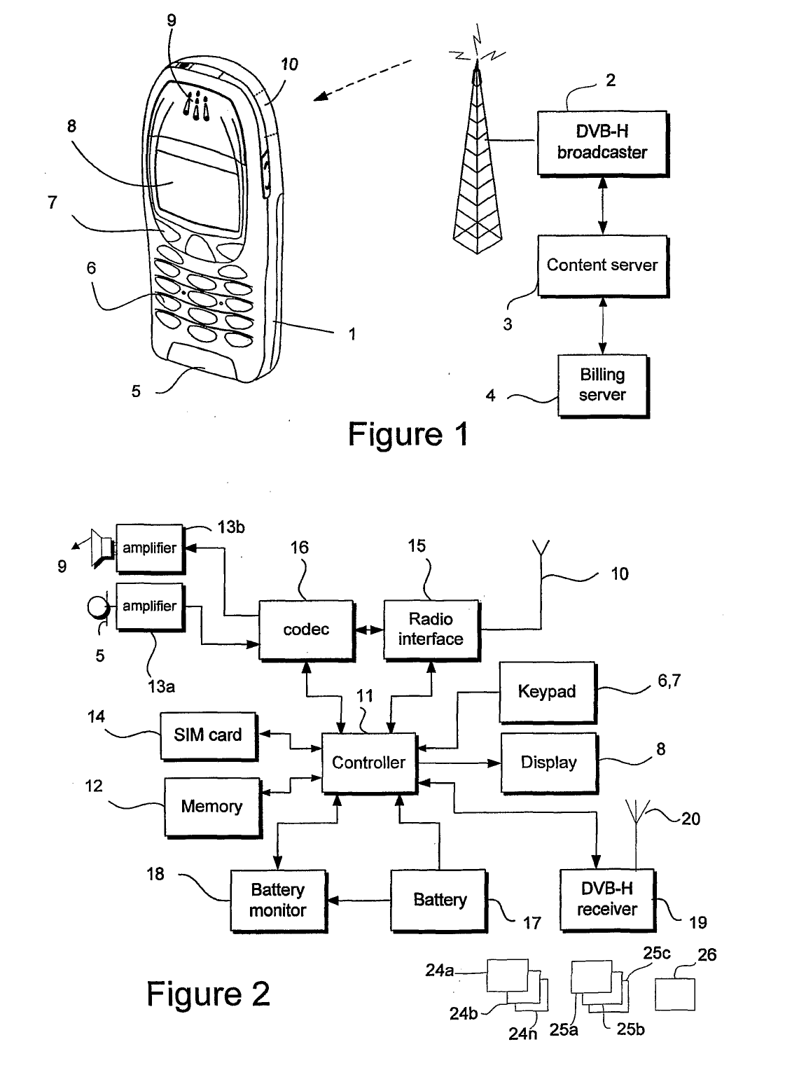

FIG. 1 is a schematic block diagram illustrating a mobile telephone handset which receives data from a server delivered by a broadcaster;

FIG. 2 is a schematic block diagram of the circuitry of the mobile handset shown in FIG. 1;

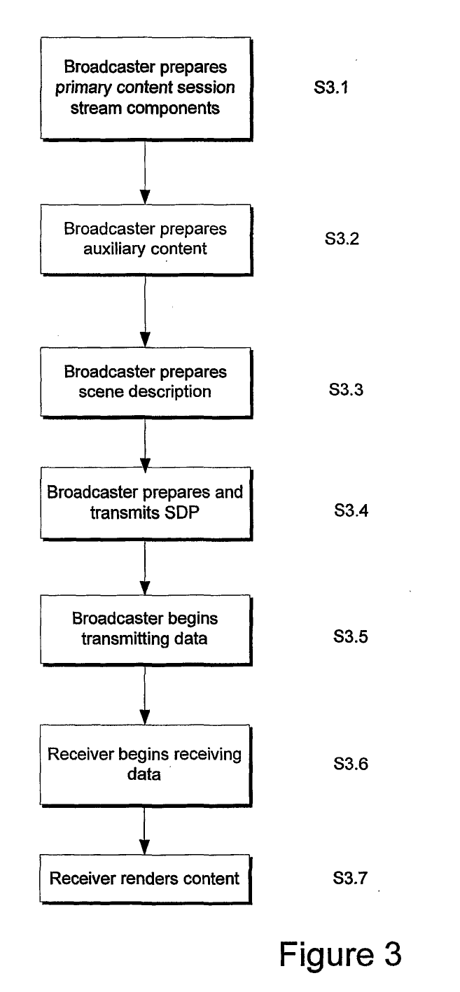

FIG. 3 is a flowchart illustrating operation of the FIG. 1 broadcaster and the FIG. 2 handset in receiving files broadcast as part of a file delivery session according to various embodiments of the invention; and

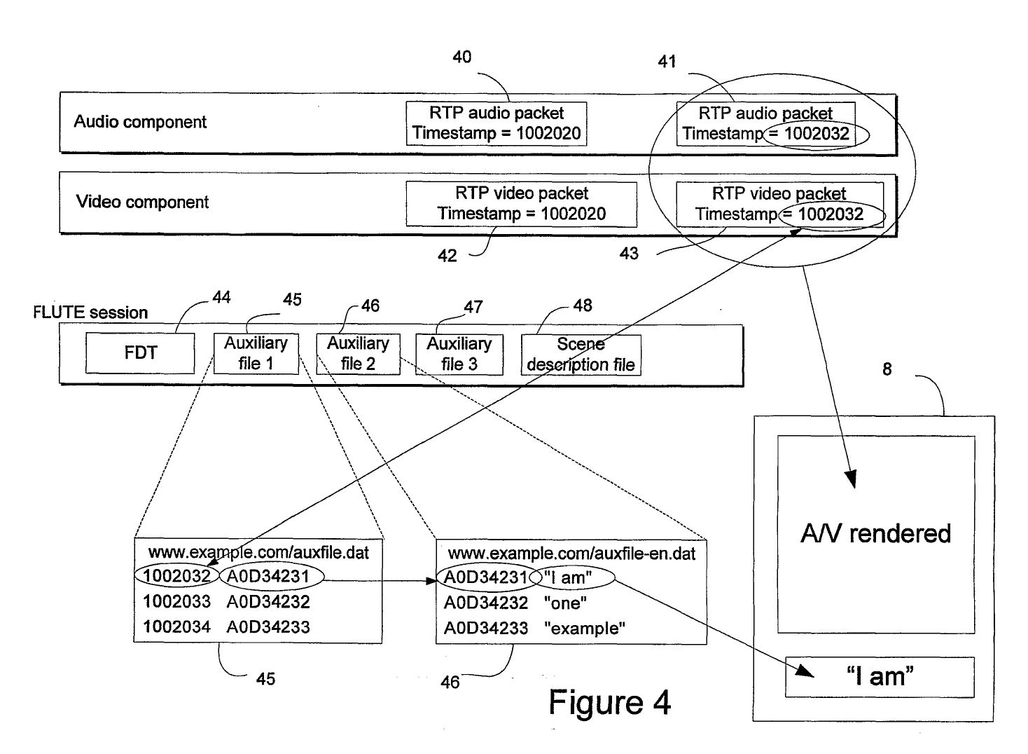

FIG. 4 illustrates how data may be delivered by the FIG. 1 broadcaster and rendered by the FIG. 2 handset.

In FIG. 1, a mobile station in the form of a mobile telephone handset 1 receives broadcast data from a DVB-H broadcaster 2, which is connected (optionally through a network (not shown)) to a content server 3 that can download data content to the mobile handset 1. The content server 3 has an associated billing server 4 for billing the subscriber for downloaded content.

The handset 1 includes a microphone 5, keypad 6, soft keys 7, a display 8, earpiece 9 and internal antenna 10. The handset 1 is enabled both for voice and data operations. For example, the handset may be configured for use with a GSM network and may be enabled for DVB-H operation, although those skilled in the art will realise other networks and signal communication protocols can be used. Signal processing is carried out under the control of a controller 11. An associated memory 12 comprises a non-volatile, solid state memory of relatively large capacity, in order to store data downloads from the content server 3, such as application programs, video clips, broadcast television services and the like. Electrical analogue audio signals are produced by microphone 5 and amplified by preamplifier 13a. Similarly, analogue audio signals are fed to the earpiece 9 or to an external headset (not shown) through an amplifier 13b. The controller 11 receives instruction signals from the keypad and soft keys 6, 7 and controls operation of the display 8. Information concerning the identity of the user is held on removable smart card 14. This may take the form of a GSM SIM card that contains the usual GSM international mobile subscriber identity and encryption key Kᵢ that is used for encoding the radio transmission in a manner well known per se. Radio signals are transmitted and received by means of the antenna 10 connected through an rf stage 15 to a codec 16 configured to process signals under the control of the controller 11. Thus, in use, for speech, the codec 16 receives analogue signals from microphone amplifier 13a, digitises them into a form suitable for transmission and feeds them to the rf stage 15 for transmission through the antenna 10 to a PLMN (not shown in FIG. 1). Similarly, signals received from the PLMN are fed through the antenna 10 to be demodulated by the rf stage 15 and fed to codec 16 so as to produce analogue signals fed to the amplifier 13a and earpiece 9.

The handset can be WAP enabled and capable of receiving data for example, over a GPRS channel at a rate of the order of 40 kbit/sec. It will however be understood that the invention is not restricted to any particular data rate or data transport mechanism and for example WCDMA, CDMA, GPRS, EDGE, WLAN, BT, DVB-T, IPDC, DAB, ISDB-T, ATSC, MMS, TCP/IP, UDP/IP or IP, systems could be used.

The handset 1 is driven by a conventional rechargeable battery 17. The charging condition of the battery is monitored by a battery monitor 18 which can monitor the battery voltage and/or the current delivered by the battery 17.

The handset also includes a DVB-H receiver module 19. This receives broadcast signals from the DVB broadcaster 2 through a DVB antenna 20.

A user of handset 1 can request the downloading of data content from one or more servers such as server 3, for example to download video clips and the like to be replayed and displayed on the display 8. Such downloaded video clips are stored in the memory 12. Also, other data files of differing sizes may be downloaded and stored in the memory 12. Downloading may be user-initiated, or may be allowed by a user on the basis of a setting of the handset.

In FLUTE, a file delivery session has a start time and an end time, and involves one or more channels. One or both of the start and end times can be undefined, that is one or both times may not be known by a receiver. If there are plural channels used in a session, these may be parallel, sequential or a mixture of parallel and sequential. A file delivery session carries files as transport objects. When a transport object is provided with semantics, the object becomes a file. Semantics may include name, location, size and type. Thus a file is a transport object which includes semantics, such as a filename or a location, e.g. a URL. Each file delivery session carries zero, one or more transport objects (TOs). Each TO is delivered as one or more packets, encapsulated in the underlying protocol. A particular packet may appear several times per session. A particular TO may be delivered using one channel or using several channels. A TO may be transmitted several times.

Although data in RTP packets are part of unbounded streams, files are bounded. In ALC, a file (object) has a number of features not present in RTP packets. These include (usually) a bounded size, and an object identifier, among other things. In FLUTE, the file is always bounded in size and has a URI (among other things). The filename can be taken from the URI, or otherwise obtained. Since the URI={URN, URL}, the filename can be, and advantageously is, derived from the URL. Otherwise, the filename can be derived from further FDT extensions, some other metadata, or extracted from an archive, such as a tarball or gzip archive.

The arrival of a complete file is significantly different from receiving a stream. Although a stream (e.g. media or session) can end and even be punctuated; a file delivery session delivers one or more files which have boundaries independent of the mode of transport.

The URI is a file identifier. The URI may also be used to name the file. The URI may be used to locate the file directly (URL) or indirectly through reference (URN or URL).

A first embodiment of the invention will now be described with reference to the Figures. In FIG. 3, the broadcaster 2 at step S3.1 prepares primary content session stream data components, using content provided by the content server 3. This is carried out in a conventional manner. In this example, a streaming session is a multimedia session consisting of an audio and a video component. At step S3.2, the broadcaster 2 prepares auxiliary content files. In this example, the auxiliary content is subtitle text, although the invention has broader application than this.

The auxiliary data is provided using a two-level structure. The first level is a file having the filename www.example.com/auxfile.dat, which has plural entries each having the following format:

<control field> <preference field>

Thus, for each entry there is a control field in which control data, or, put another way, a control information item, is found, and a reference field in which a reference is found.

Example contents of the file www.example.com/auxfile.dat are:

### 1002032 A0D34231

### 1002033 A0D34232

### 1002034 A0D34233

Here, there are three entries. The control data are timestamps, and the references are eight digit hexadecimal numbers.

The second level includes two files each of which has plural entries with the following format:

<reference field> <content field>

Thus, in each second level file and for each entry there is a reference field in which a reference is found, and a content field in which a content item is found.

Example contents of a first one of the second level files, named www.example.com/auxfile-en.dat file, follow:

### A0D34231 “I”

A0D34232 “am”
A0D34233 “one”

Thus, in the second level file there are a number of entries equal to the number of entries in the first level file. The references are eight digit hexadecimal numbers, and the content items are strings of ASCII text.

A second file on the second level is named www.example.com/auxfile-fi.dat and has the following contents:

### A0D34231 “Ma”

A0D34232 “olen”
A0D34233 “yksi”

This file is generally the same as the file www.example.com/auxfile-en.dat except that its filename denotes Finnish language content, instead of English language content, and its content fields include Finnish language text strings. The references are the same in both of the second level files.

Thus, the auxiliary data comprises three files having different filenames and different contents.

At step S3.3, the broadcaster prepares a scene description file. This file is a SMIL 2.0 file which defines locations and sizes of regions of the display 8 of a receiver and defines what content is associated with those regions. The scene description file may also include some timing information, particularly in respect of audio and video content. The scene description file defines a display region for the auxiliary data. Where the auxiliary data is subtitle text, this region may be a wide strip of relatively low height placed at or near the bottom of the display. A region for the presentation of video content may be located above the subtitle text region. Alternatively, the video content region may occupy the entire display, and the subtitle region may overlay the video content region such that rendered subtitles obscure any part of an image immediately behind them. The locations of the regions may be defined in absolute terms, or may be defined relative to another region. The scene description file is named www.example.com/scene.smil.

At step S3.4, the broadcaster 2 prepares and transmits a session description protocol (SDP) file. In this SDP file, a description of the streaming session is instantiated. Also, the auxiliary data description is instantiated as a media element and included in the SDP file. The auxiliary data delivery is described in the SDP description. The scene description delivery is described in the SDP description. An example SDP file is:

v=0
o=user1 2890844526 2890842807 IN IP4 126.16.64.4
s=Example
i=An example SDP
c=IN IP4 224.2.17.12/127
t=2873397496 2873404696
a=stream-local-file:stream.mov
m=audio 49170 RTP/AVP 0
m=video 51372 RTP/AVP 31
m=aux 12345 ALC/FLUTE
a=aux-root:www.example.com/auxfile.dat
a=aux-file:lang=en:www.example.com/auxfile-en.dat
a=aux-file:lang=fi:www.example.com/auxfile-fi.dat
a=scene-url:www.example.com/scene.smil

This SDP file states that a FLUTE session in address 224.2.17.12:12345 is used to carry four files, namely: the first level auxiliary file: www.example.com/auxfile.dat; the second level auxiliary files: www.example.com/auxfile-en.dat and www.example.com/auxfile-fi.dat; and the scene description file www.example.com/scene.smil.

The SDP file is delivered using ALC/FLUTE or SAP or similar over multicast/broadcast addressing.

At step S3.5, the broadcaster 2 begins transmitting the data. The streaming session is carried over RTP/UDP/IP. The auxiliary data is carried using FLUTE/ALC/UDP/IP. The scene description is carried using FLUTE/ALC/UDP/IP. This is illustrated in FIG. 4. In this Figure, streamed audio packets 40, 41 and video packets 42, 43 are provided with presentation timestamps and are shown as being RTP packets. A FLUTE session comprises first to fifth objects 44 to 48. The first object 44 is an FDT, which declares the other files 45 to 48 as belonging to the FLUTE session. The second to fifth objects are the auxiliary data files www.example.com/auxfile.dat, www.example.com/auxfile-en.dat, www.example.com/auxfile-fi.dat; and www.example.com/scene.smil respectively.

As step S3.6 of FIG. 3, the receiver 1 begins receiving the data transmitted by the broadcaster. This involves a number of preliminary steps, namely examining the contents of one or more FDTs, such as the FDT 44. File descriptors in the FDT relating to the auxiliary data files 45 to 48 are examined. From these file descriptors, the TOs which include the auxiliary data files 45 to 48 can be identified. The receiver 19 can then determine which transmitted TOs are required to be received and decoded by identifying the relevant TOs from the file descriptors in the FDT 44. The receiver 1 receives the SDP file over ALC/FLUTE or SAP. The receiver 1 prepares to receive the streaming session (the audio and video components carried over RTP) and prepares to receive the auxiliary data and scene description (carried in ALC/FLUTE session). Then the receiver 1 can receive the auxiliary data files and the scene description file. Independently, the receiver 1 can start to receive the audio and video components of the streaming session. These steps may occur in any suitable order.

At step S3.7, the receiver 1 renders the content once all the required data has been received. This involves decoding the audio and video components in preparation for rendering extracting appropriate auxiliary data and preparing it for rendering, and providing a scene according to the scene defined in the scene description file. Where there are plural second level auxiliary data files, as there are in this example, the receiver must select one of them as being the appropriate file. This can occur in any suitable way, either automatically by the receiver 1 or through user input. In this example, the English language second level file is deemed appropriate. The receiver 1 renders the streamed session and the auxiliary data at the times designated by the timestamps included in the audio and video packets 40 to 43 and the timestamps included in the first level auxiliary data file. The subtitle content that is rendered at a given time is that content in the second level file which is in the entry with the same reference as the reference given in the entry in the first level file which has the appropriate timestamp.

An auxiliary content item is rendered until the following content item is due to be rendered, so there is continuity of auxiliary content presentation. The video content is rendered at the top part of the display, and the subtitle text is rendered at the bottom part of the display, as defined by the scene description file. This is illustrated in FIG. 4. Here, in the display 8, at a time relating to timestamp 1002032, video content from the packet 43 having that timestamp is rendered in a large top region, and subtitle text from the English language second level file 46 having the same reference as the reference corresponding to the timestamp in the first level file 45 is rendered at the bottom of the display.

Using this scheme, the broadcaster 2 can define exactly when auxiliary content items, in this case subtitle text strings, are to be rendered but without requiring streaming of packets including the auxiliary data. Using the same control information, i.e. using timestamps for the streamed content and the auxiliary content items, makes it relatively easy for a receiver 1 to ensure that the auxiliary data remains synchronised with the primary content. Delivering a file including plural auxiliary content data items for later rendering provides numerous advantages over streaming auxiliary data. In particular, it allows auxiliary data for a significant period of time, for example 10 minutes or an hour, to be transmitted in advance and referenced to local storage in the receiver 1. This allows the receiver 1 to receive one fewer streamed session than would be required if the auxiliary data were streamed, allowing increased reliability of service reception and rendering.

In the first embodiment, the receiver is able to process only one type of auxiliary content data, or else is required to determine the auxiliary content data type from the auxiliary content itself without being informed of it. In a second embodiment, the content type is identified in the first level auxiliary data file. In this case, the first level auxiliary data file 45, named www.example.com/auxfile.dat, includes entries having the following data fields:

<control field> <content type field> <reference field>

An example file follows:

1002032 text/ascii A0D34231
1002033 text/html A0D34232
1002034 image/gif A0D34233

It will be appreciated that this is the same as the first level file of the first embodiment described above except that each entry includes an additional data item, which is descriptive of the type of the content to which the entry relates, interposed between the control data and the reference for that entry.

The second level auxiliary data file 46 is formatted in the same way as that of the first embodiment. However, the file 46 can contain content of different types, as follows:

### A0D34231 “I”

A0D34232<html> . . . </html>
A0D34233 0x2ab832739ef2i80

When auxiliary data files of this nature are prepared and transmitted by the broadcaster 2, a receiver 1 can use the data from the content type field for each entry to ensure that the corresponding content is handled and rendered suitably. This also allows a receiver 1 to handle different content types within a service, such as a television program. With the example auxiliary files given above, the receiver 1 is able to render ASCII text, HTML text and a GIF image in a sequence, whereas this would have not been possible or would have been more difficult for the receiver 1 to handle correctly if the content type information were not present, as occurs for example with the first embodiment described above.

In a third embodiment, the content type information field is included instead in the second level auxiliary data file 46. In this embodiment, the first level data file 45 is the same as that shown for the first embodiment above. The second level auxiliary data file 45 named www.example.com/auxfile-en.dat, includes entries having the following data fields:

<reference field> <content type field> <content field>

An example file follows:

A0D34231 text/ascii “I”
A0D34232 text/html <html> . . . </html>
A0D34233 image/gif 0x2ab832739ef2i80

When auxiliary data files of this nature are prepared and transmitted by the broadcaster 2, a receiver 1 can use the data from the information type field for each entry to ensure that the corresponding content is handled and tendered suitably. This also allows a receiver 1 to handle different content types within a service, such as a television program. With the example auxiliary files given above, the receiver 1 is able to render ASCII text, HTML text and a GIF image in a sequence, whereas this would have not been possible or would have been more difficult for the receiver to handle correctly if the content type information were not present, as for example with the first embodiment described above.

In the first to third embodiments, two levels of auxiliary data files are used. In a fourth embodiment, there is only one level of auxiliary data file. Here, the one file includes bookmarks, and the references point to bookmarks. Each entry in the file has the following fields:

<control field> <reference field>

An example file follows:

### 000123 This is

000126 a fourth
000140 example

Here, the bookmarks also appear in the played out content (e.g. appear in SMIL or in the RTP stream, etc.) and thus could be mapped to the part of the file to synchronise with them. This appearance of the bookmark may be implicit (e.g. 000123 could be “12.3 seconds” into playout), or the appearance of the bookmark may be explicit (e.g. an RTCP SR could include a bookmark).

In a fifth embodiment, a single level of auxiliary data files is used, and each entry in the file includes a content type information field. In this case, the following fields are present for each entry:

<control field> <content type field> <content field>

An example file follows:

000123 text/ascii “This is an example”
000126 image/gif 0x2ab832739ef2i80
000140 text/html <html> . . . </html>
000145 url www.example.com/more.html

In this file, ASCII text is followed by a GIF image and by HTML text auxiliary data. The last entry points to a resource identified by the URL, as denoted by the ‘url’ content type information in the content type information field. The type of the content pointed to by the URL typically will be denoted by content type information included in the file at the URL, or by the file extension.

When an auxiliary data file of this nature is prepared and transmitted by the broadcaster 2, a receiver 1 can use the data from the information type field for each entry to ensure that the corresponding content is handled and rendered suitably. This also allows a receiver 1 to handle different content types within a service. With the example auxiliary files given above, the receiver 1 is able to render ASCII text, a GIF image, HTML text and content pointed at by a URL in a sequence, whereas this would have not been possible or would have been more difficult for the receiver to handle correctly if the content type information were not present, as for example with the first embodiment described above.

Although in the above embodiments the broadcaster 2 is described as preparing the auxiliary data files, the scene description file, the streaming session packets and the SDP file, this is not critical, and some or all of this material may be prepared instead by one or more other operators.

Also, although in the above embodiments the receiver 1 waits until all the required data has been received before rendering the content, this is not essential. For instance, the receiver may instead begin rendering content once a sufficient amount of the data has been received, and continue to receive data as a background task. This can allow the rendering of content to be commenced at an earlier time than would be possible if the receiver needed to wait for all the data to be received. Alternatively, some of the data may be received in advance before rendering begins whilst some of the data is continued to be received after rendering begins. For example, the auxiliary data may all be received in advance, but the audio and video content may be begun to be rendered before it has been received in full.

Instead of the references in the files of a two level auxiliary data file system being the same in the first and second level auxiliary data file, they may be different. It is important only that a receiver 1 can determine the correct time at which to render auxiliary content, so as to ensure that it is synchronised with the primary content. However, using the same references provides a simper system.

Furthermore, instead of the control information in the auxiliary data files being the same as the control information, e.g. timestamps, in primary content packets, they may be different. It is important only that a receiver 1 can determine the correct time at which to tender auxiliary content, so as to ensure that it is synchronised with the primary content. There may for example be mapping between control information associated with the auxiliary data and timestamps associated with streamed content.

Whereas in the above embodiments an item of auxiliary content is tendered until the next auxiliary content item is due to be rendered, this is not essential. For instance, entries in an auxiliary data file may be provided with start and end timestamps, at which the auxiliary content item is begun and ceased to be rendered respectively. This can allow the auxiliary content display region to be empty when required, for instance at times when there is no dialogue in the primary audio content. An auxiliary data file may include both entries with start and end timestamps and entries which relate to contiguous auxiliary content items, i.e. entries with only a start timestamp, where rendering of the auxiliary content item is ended when the next auxiliary content item is tendered.

Many other modifications and variations of the described system are possible. For example whilst the invention has been described in relation to a mobile telecommunications handset, particularly a mobile telephone, it is applicable to other apparatus useable to receive files in delivery sessions. Transmission may be over-the-air, through DVB or other digital system. Transmission may instead be through a telephone or other wired connection to a fixed network, for example to a PC or server computer or other apparatus through an Internet multicast.

Although SMIL is used above to define presentations, any other language or technique could be used instead. Such may be a publicly available standard, or may be proprietary. One standard which may be used is Timed Interactive Multimedia Extensions for HTML (HTML+TIME), which extends SMIL into the Web Browser environment.

HTML+TIME includes timing and interactivity extensions for HTML, as well as the addition of several new tags to support specific features described in SMIL 1.0. HTML+TIME also adds some extensions to the timing and synchronization model, appropriate to the Web browser domain. HTML+TIME also introduces a number of extensions to SMIL for flexibility and control purposes. An Object Model is described for HTML+TIME.

Although the embodiments are described in relation to IPDC over DVB-H, the invention can be applied to any system capable in supporting one-to-one (unicast), one-to-many (broadcast) or many-to-many (multicast) packet transport. Also, the beater of the communication system may be natively unidirectional (such as DVB-T/S/C/H, DAB) or bi-directional (such as GPRS, UMTS, MBMS, BCMCS, WLAN, etc.). Instead of receiving the various data using broadcast or multicast, some or all of the data may instead be pushed to the receiver 1, for example using 3GPP/OMA PUSH, and/or fetched from a server by the receiver 1, for example using HTTP or FTP.

Some of the data needed to render the content may be pre-configured or otherwise already known to the receiver 1. For example, the receiver may know in advance that the language is always US-English for a certain file mime type, or that video playout is to be a constant 2 Mbps +/−a variable. The receiver may know that the video is H.263 and the audio mp3 in an .avi file, e.g. in a recorded avi file.

The SDP file and/or one or more auxiliary data files and/or the scene description file may be instantiated as user entered data, as data generated from metadata, and/or as protocol messages. User entered data may be data which the user manually enters the parameters using the keypad, or drags-and-drops the files to an application. Data generated from metadata may be for example, some miscellaneous metadata used to generate the equivalent parameters that would be found from SDP etc. This may or may not result in the production of an SDP file in messages and/or on a file system. Also applies to SMIL and other files (as well as SDP). Protocol messages are for example binary encoded messages that can have parameters to reconstruct the SDP (and other) info. For example, FLUTE/ALC headers may contain data that could be available in an SDP description of a Flute session (e.g. codepoint->FEC encoding id).

Data packets may be IPv4 or IPv6 packets, although the invention is not restricted to these packet types.

1. A method comprising delivering:
one or more primary content items; and
one or more auxiliary items each comprising a file containing plural control information items; and
a) an auxiliary content item, or
b) a reference to an auxiliary content item, corresponding to each control information item.

2. A method as claimed in claim 1, in which the delivering of the file comprises transmitting over ALC/FLUTE or SAP.

3. A method as claimed in claim 1, in which the file contains the auxiliary content items corresponding to the control information items, and in which the file also contains a content type indicator item for each of at least some of, or all of, the auxiliary content items.

4. A method as claimed in claim 1, in which the file contains references to the auxiliary content items, the method comprising delivering one or more further files containing plural references and corresponding auxiliary content items.

5. A method as claimed in claim 4, comprising delivering first and second further files containing at least some of the same references as each other but different auxiliary content items.

6. A method as claimed in claim 4, in which the one or more further files contain a content type indicator item for each of at least some of, or all of, the auxiliary content items.

7. A method as claimed in claim 1, comprising delivering a session description information object which identifies the file.

8. A method as claimed in claim 7, in which the session description information object describes a streaming session carrying the one or more primary content items.

9. A method as claimed in claim 7 in which the session description information object describes a scene description object, such as a scene description file.

10. A method as claimed in claim 1, comprising delivering a scene description object, such as a scene description file.

11. A method as claimed in claim 10, in which the scene description object is described in a or the session description information object.

12. A method as claimed in claim 1, in which the control information items are time reference items.

13. A system, comprising:
a broadcaster arranged to deliver:
one or more primary content items; and
one or more auxiliary items each comprising a file containing plural control information items; and
a) an auxiliary content item, or
b) a reference to an auxiliary content item, corresponding to each control information item.

14. A system as claimed in claim 13, arranged to deliver the file or files over ALC/FLUTE or SAP.

15. A system as claimed in claim 13, in which the file contains the auxiliary content items corresponding to the control information items, and in which the file also contains a content type indicator item for each of at least some of, or all of, the auxiliary content items.

16. A system as claimed in claim 13, in which the file contains references to the auxiliary content items, the system being arranged to deliver one or more further files containing plural references and corresponding auxiliary content items.

17. A system as claimed in claim 16, arranged to deliver first and second further files containing at least some of the same references as each other but different auxiliary content items.

18. A system as claimed in claim 16, in which the one or more further files contain a content type indicator item for each of at least some of, or all of, the auxiliary content items.

19. A system as claimed in claim 13, comprising delivering a session description information object which identifies the file.

20. A system as claimed in claim 19, in which the session description information object describes a streaming session carrying the one or more primary content items.

21. A system as claimed in claim 19 in which the session description information object describes a scene description object, such as a scene description file.

22. A system as claimed in claim 13, comprising delivering a scene description object, such as a scene description file.

23. A system as claimed in claim 22, in which the scene description object is described in a or the session description information object.

24. A system as claimed in claim 13, in which the control information items are time reference items.

25. A method comprising:
receiving:
one or more primary content items, and
one or more auxiliary items each comprising a file containing plural control information items, and a) an auxiliary content item, or b) a reference to an auxiliary content item, corresponding to each control information item; and
using the control items to render content from corresponding auxiliary content items along with primary content from the primary content items.

26. A method as claimed in claim 25, in which the file receiving step comprises controlling an ALC/FLUTE or SAP receiver to receive the file.

27. A method as claimed in claim 25, in which the received file contains the content items corresponding to the control information items, and in which the file also contains a content type indicator item for each of at least some of, or all of, the content items, the method comprising using the content type indicator items to render the corresponding auxiliary content.

28. A method as claimed in claim 27, in which the received file contains references to the content items, the method comprising receiving one or more further files containing plural references and corresponding content items, and using the references to identify auxiliary content items associated with the control information items.

29. A method as claimed in claim 28, comprising selecting one of two or more of the one or more further files, rendering the auxiliary content from that file, and refraining from rendering auxiliary content from the other further files.

30. A method as claimed in claim 28, in which the one or more further files contain a content type indicator item for each of at least some of, or all of, the content items, the method comprising using the content type indication items to render the corresponding auxiliary content.

31. A method as claimed in claim 25, comprising using time references forming part of the primary content items along with the control information items to synchronise the primary content with the auxiliary content.

32. A method as claimed in claim 25, comprising receiving a session description information object, and using the session description information to identify the auxiliary items.

33. A method as claimed in claim 25, comprising receiving a scene description object, such as a scene description file, and using the scene description object to render the primary and auxiliary content.

34. A method as claimed in claim 25, in which the control information items are time reference items.

35. A system, comprising:
a receiver arranged, in response to receiving:
one or more primary content items, and
one or more auxiliary items each comprising a file containing plural control information items, and a) an auxiliary content item, or b) a reference to an auxiliary content item, corresponding to each control information item,
to use the control items to render content from corresponding auxiliary content items along with primary content from the primary content items.

36. A system as claimed in claim 35, in which the receiver is arranged to use an ALC/FLUTE or SAP receiver to receive the file.

37. A system as claimed in claim 35, in which the received file contains the content items corresponding to the control information items, and in which the file also contains a content type indicator item for each of at least some of, or all of, the content items, the receiver being arranged to use the content type indicator items to render the corresponding auxiliary content.

38. A system as claimed in claim 37, in which the received file contains references to the content items, the receiver being responsive to receiving one or more further files containing plural references and corresponding content items to use the references to identify auxiliary content items associated with the control information items.

39. A system as claimed in claim 38, the receiver being arranged to select one of two or more of the one or more further files, to render the auxiliary content from that file, and to refrain from rendering auxiliary content from the other further files.

40. A system as claimed in claim 38, in which the one or more further files contain a content type indicator item for each of at least some of, or all of, the content items, the receiver being arranged to use the content type indication items to render the corresponding auxiliary content.

41. A system as claimed in claim 35, the receiver being arranged to use time references forming part of the primary content items along with the control information items to synchronise the primary content with the auxiliary content.

42. A system as claimed in claim 35, the receiver being arranged to use received session description information to identify the auxiliary items.

43. A system as claimed in claim 35, the receiver being arranged to use a received scene description object, such as a scene description file, to render the primary and auxiliary content.

44. A system as claimed in claim 35, in which the control information items are time reference items.

45. A method comprising:
delivering, by a sender:
one or more primary content items; and
one or more auxiliary items each comprising a file containing plural control information items; and
a) an auxiliary content item, or
b) a reference to an auxiliary content item,
corresponding to each control information item;
receiving, by a receiver, the one or more primary content items, and the one or more auxiliary items; and
using, by the receiver the control items to render content from corresponding auxiliary content items along with primary content from the primary content items.

46. A computer program product, embodied in a computer-readable medium, for content delivery, comprising:
computer code for delivering:
one or more primary content items; and
one or more auxiliary items each comprising a file containing plural control information items; and
a) an auxiliary content item, or
b) a reference to an auxiliary content item,
corresponding to each control information item.

47. A computer program product, embodied in a computer-readable medium, for handling content, comprises
computer code for, in response to receiving:
one or more primary content items, and
one or more auxiliary items each comprising a file containing plural control information items, and a) an auxiliary content item, or b) a reference to an auxiliary content item, corresponding to each control information item,
using the control items to render content from corresponding auxiliary content items along with primary content from the primary content items.
